(19) United States
(12) Patent Application Publication
(10) Pub. No.: US 2015/0260149 A1
(43) Pub. Date: Sep. 17, 2015

(54) METHOD FOR RETRIEVING AND USING NATURAL RESOURCES

(71) Applicant: XYZ SCIENCE CO., LTD., New Taipei City (TW)

(72) Inventor: CHIU-SAN LEE, New Taipei City (TW)

(73) Assignee: XYZ SCIENCE CO., LTD., New Taipei City (TW)

(21) Appl. No.: 14/205,345

(22) Filed: Mar. 11, 2014

(51) Int. Cl. F03B 13/08

(52) U.S. Cl. CPC F03B 13/08

(57) ABSTRACT

A method for retrieving and using natural resources including arranging a reservoir in a river that is provided with a hydraulic power generation facility to generate power and arranging a hydraulic press facility to drawing river water to a water quality inspection facility to inspect and supply drinking water and water for cleaning, arranging an aggregate sieving and collecting area that includes a floating wood/branch/leaf intercepting zone in the river for intercepting floating wood, which serves as fuel for a thermal power generation facility, and collecting aggregates, which is conveyed to a desalting area for being desalted, arranging an air collection facility in an upstream site for collecting and conveying fresh air containing phytoncide to a compression and storage facility to produce packaged air or to an air cooling/heating facility for supplying fresh cooled/heated air, and electrical power being supplied from the power generation facilities for operations of the facilities.

### TECHNICAL FIELD OF THE INVENTION

The present invention generally relates to a method for retrieving and using natural resources, and more particularly to a method for retrieving and using natural resources that is environment-protective, energy-saving, and power-saving and is beneficial to environment and air.

### DESCRIPTION OF THE PRIOR ART

Aggregates are generally classified as land aggregates, stream aggregates, river aggregates, and sea aggregates. A different way of classification can be made according to the contents of salt, whereby the former three types of aggregates are collectively referred to as freshwater aggregates, while the later one is referred to saltwater aggregates for they have stayed in sea and in close contact with rich salts. All these types of aggregates are initially from land and mountains and contain an amount of salts and are moved through rainwater washing, muddy flow, or water erosion to streams and rivers. Some of the aggregates may be kept in the streams and rivers and are subjected to continuous washing by river water to thus contain a less amount of salts. For those aggregates that are moved into seas, due to the high content of salts in the seawater, the aggregates absorb the salts and become seawater aggregates. The seawater aggregates, when mixed with cement to construct for example ceilings and walls in the construction of buildings, may release the salts to make it impossible for application of paints to the wall surface or efflorescence, making the wall surface bulging, separating, or even exploding, and potentially affecting steel structures (such as reinforcement bars) by corroding or breaking them. This is “efflorescence”. Buildings that are constructed with seawater aggregates are often referred to as seawater aggregate building and it has been stipulated in regulations and laws that no seawater aggregates can be used in buildings. However, these aggregates was originated from the land and then moved to the sea. If they are not properly retrieved for use, they will eventually occupy a great amount of space of the sea bottom, leading to rise of sea surface and lowering of land.

One of the conventional ways of collecting aggregates is to directly dig river aggregates from riverbanks. This surely deteriorates the landscape of the river shores, pollutes river water, and damage the environment, and may also cause a large amount of river aggregates to flow into the seas, becoming sea aggregates, making seawater muddy, affecting the landscape view of sea surface, and leading to rise of sea surface due to the accumulation of sea aggregates. Further, the amount of river aggregates acquired in this way is limited.

Thus, it is desired to provide a solution to overcome such problems and drawbacks.

### SUMMARY OF THE INVENTION

In view of the above problems and drawbacks, the present invention aims to provide a method for retrieving and using natural resources that is environment-protective, energy-saving, power-saving, and is beneficial to the environment and air.

The primary object of the present invention is to preserve the natural environment, to save energy, and to achieve carbon reduction.

Another object of the present invention is to improve the quality of the surrounding environment and atmosphere.

To achieve the above objects, the present invention arranges at least a reservoir and at least one hydraulic press facility at an upstream site of a river, and arranges at least a hydraulic power generation device on the reservoir to make use of the river water for power generation, wherein the hydraulic press facility pumps the river water to at least one water quality inspection facility for inspection of water quality and transports, in response to the result of water quality inspection, the river water to a packaged drinking water facility, a drinkable tap water facility, or an industrial tap water facility for supply of water for drinking and/or use; arranges an air collection facility in remote mountains at an upstream site of the river to collect and convey fresh mountain air that contains plant phytoncide to a compression and storage facility to produce packaged air or to be transported to an air cooling/heating facility for supplying fresh cooled/heated air; arranges at least one aggregate sieving and collecting area on the river, wherein the aggregate sieving and collecting area comprises, in sequence, a floating wood/branch/leaf intercepting zone, at least one path-divided track tray, and a bottomland zone for sediment and deposition of soil/earth, the intercepted floating wood/branch/leaf being conveyed to a thermal power generation device to serve as fuel, aggregate being separated based on size and transported to a desalting area for removing salt from the aggregate, wherein the thermal power generation device, when put into operation, releases thermal energy that is used to assist salt removal carried out in the desalting area; and the hydraulic power generation device and the thermal power generation device supply electrical power necessary for the operations of the present invention, or alternatively or additionally, at least one wind power generation device, at least one solar energy generation device, or at least one tidal power generation device is installed to supply the necessary electrical power. With such an arrangement, the present invention can overcome the problems of the conventional ways of mining aggregates that deteriorate riverside landscape, pollute river water, and damage the environment and achieve the practical advantages of environmental protection, energy saving, and power saving, and being beneficial to the environmental and atmosphere.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating a method according to a preferred embodiment of the present invention.

FIG. 2 is a flow chart illustrating the method according to the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

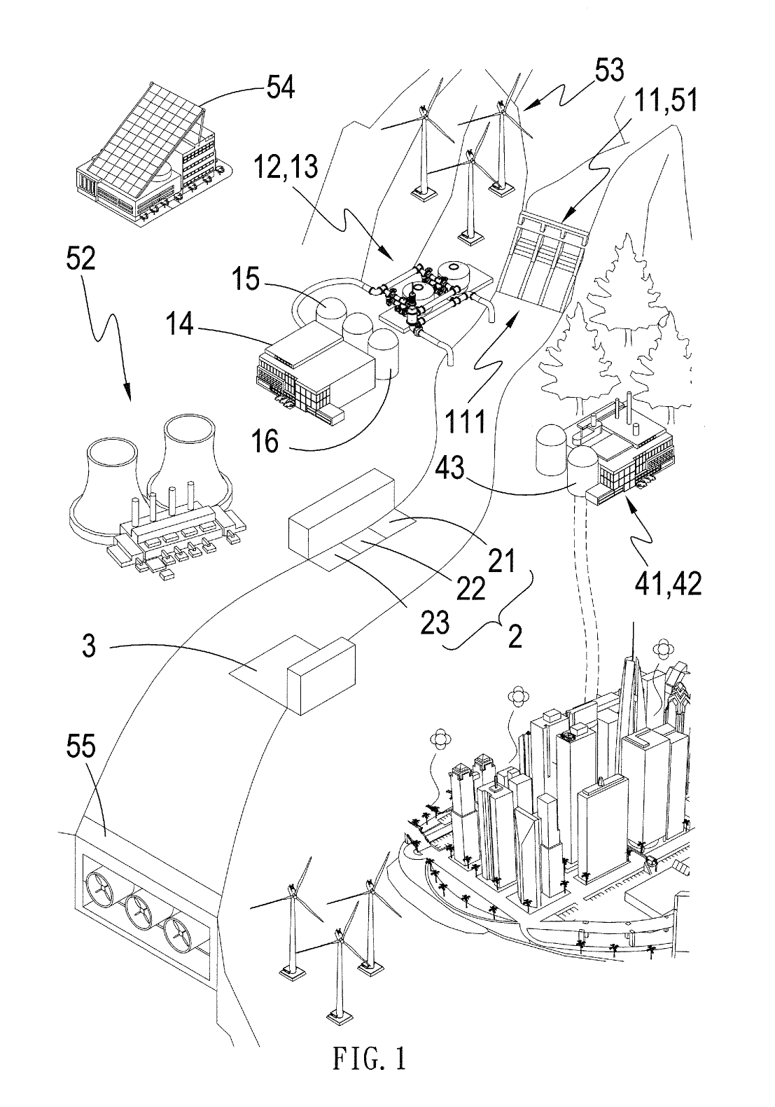

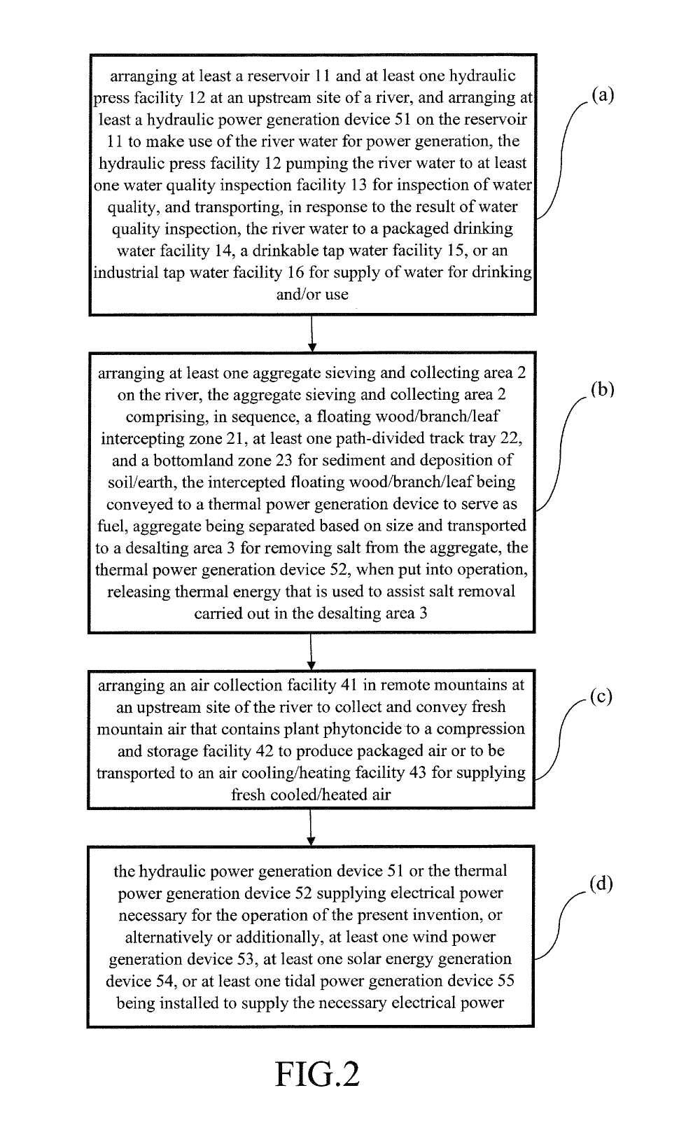

Referring to FIGS. 1 and 2, which are respectively a schematic view illustrating a method for retrieving and using natural resources according to the present invention and a flow chart illustrating the method for retrieving and using natural resources according to the present invention, the drawings clearly show the method of retrieving and using natural resources according to the present invention is as follows:

(a) arranging at least a reservoir 11 and at least one hydraulic press facility 12 at an upstream site of a river, and arranging at least a hydraulic power generation device 51 on the reservoir 11 to make use of the river water for power generation, the hydraulic press facility 12 pumping the river water to at least one water quality inspection facility 13 for inspection of water quality, and transporting, in response to the result of water quality inspection, the river water to a packaged drinking water facility 14, a drinkable tap water facility 15, or an industrial tap water facility 16 for supply of water for drinking and/or use;

(b) arranging at least one aggregate sieving and collecting area 2 on the river, the aggregate sieving and collecting area 2 comprising, in sequence, a floating wood/branch/leaf intercepting zone 21, at least one path-divided track tray 22, and a bottomland zone 23 for sediment and deposition of soil/earth, the intercepted floating wood/branch/leaf being conveyed to a thermal power generation device to serve as fuel, aggregate being separated based on size and transported to a desalting area 3 for removing salt from the aggregate, the thermal power generation device 52, when put into operation, releasing thermal energy that is used to assist salt removal carried out in the desalting area 3;

(c) arranging an air collection facility 41 in remote mountains at an upstream site of the river to collect and convey fresh mountain air that contains plant phytoncide to a compression and storage facility 42 to produce packaged air or to be transported to an air cooling/heating facility 43 for supplying fresh cooled/heated air; and

(d) the hydraulic power generation device 51 or the thermal power generation device 52 supplying electrical power necessary for the operation of the present invention, or alternatively or additionally, at least one wind power generation device 53, at least one solar energy generation device 54, or at least one tidal power generation device 55 being installed to supply the necessary electrical power.

The above described steps (a), (b), (c), and (d), although listed in sequence, can be performed randomly and disorderly without being constrained to such an order.

In step (a), it can further be possible to arrange multiple reservoirs 11 (not shown in the drawings) at the upstream sites of the river to increase the benefit and performance of hydraulic power generation. The multiple reservoirs 11 include at least one waterfall discharging zone 111, the hydraulic power generation device 51, the hydraulic press facility 12, the water quality inspection facility 13, and the packaged drinking water facility 14 being arranged in the waterfall discharging zone 111 so that the water quality inspection facility 13 inspects the quality of the river water and transports, in response to the result of water quality inspection, the river water to the packaged drinking water facility 14, the drinkable tap water facility 15, or the industrial tap water facility 16 to achieve separate supply of water for drinking and industrial use.

In step (b), the floating wood/branch/leaf intercepting zone 21 prevents floating wood/branch/leaf from flowing to the sea and contaminating seashores. The path-divided track tray 22 has sieving holes of various sizes for intercepting aggregates of different sizes. The bottomland zone 23 helps reduce the amount of soil/sand/rock flowing to the seas to prevent seawater from becoming muddy and thus affecting the view of the sea surface. The bottomland zone 23 allows for sediment and deposition of soil/sand/rock that can be subsequently used for land filling. Further, the desalting area 3 uses the natural river water for desalting so that the cost can be reduced.

Further, in step (b), the wind power generation device 53 can be established at one side of the reservoir 11 to take advantage of the natural mountain winds for power generation.

Further, the present invention may further comprise an aggregate drawing and pumping device. The aggregate drawing and pumping device draws aggregates from the river bottom or sea bottom and the aggregates so drawn are conveyed to the aggregate sieving and collecting area 2 for sieving and desalting. The processes that can be adopted in the desalting area for desalting of the aggregates are as follows:

(1) drawing river water to wash aggregates in order to remove salt from the aggregates;

(2) drawing river water to have the river water and aggregates heated together in order to remove salt from the aggregates; and

(3) heating aggregates and then drawing river water to have the liver water mixed with the aggregates for cooling in order to remove salt from the aggregates.

Thus, the key technical features of the method for retrieving and using natural resources that overcome the drawbacks of the prior art are as follows:

(1) Huge resources that have not reached seas are retrieved and collected through natural ways to allow centralized facility to supply packaged drinking water, drinkable tap water, industrial tap water, fresh air containing phytoncide, cooled/heated air. Further, the natural resources are used for hydraulic power generation, wind power generation, thermal power generation, solar power generation, or tidal power generation. Further, aggregates are collected; soil is collected; and sea sand is retrieved for reuse. Thus, the present invention may achieve various practical advantages of environmental protection, energy saving, power consumption lowering, and being beneficial to the environment and air.

(2) The hydraulic press facility 12, the water quality inspection facility 13, the packaged drinking water facility 14, the drinkable tap water facility 15, the air collection facility 41, the compression and storage facility 42, and air cooling/heating facility 43 are used to allow the present invention to achieve the practical advantage of supplying fresh air, cooled/heated air and good quality drinking water.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for retrieving and using natural resources, comprising:
arranging at least a reservoir and at least one hydraulic press facility at an upstream site of a river, and arranging at least a hydraulic power generation device on the reservoir to make use of the river water for power generation, the hydraulic press facility pumping the river water to at least one water quality inspection facility for inspection of water quality, and transporting, in response to the result of water quality inspection, the river water to a packaged drinking water facility, a drinkable tap water facility, or an industrial tap water facility for supply of water for drinking and/or use;
arranging at least one aggregate sieving and collecting area on the river, the aggregate sieving and collecting area comprising, in sequence, a floating wood/branch/leaf intercepting zone, at least one path-divided track tray, and a bottomland zone for sediment and deposition of soil/earth, the intercepted floating wood/branch/leaf being conveyed to a thermal power generation device to serve as fuel, aggregate being separated based on size and transported to a desalting area for removing salt from the aggregate, wherein the thermal power generation device, when put into operation, releases thermal energy that is used to assist salt removal carried out in the desalting area; arranging an air collection facility in remote mountains at an upstream site of the river to collect and convey fresh mountain air that contains plant phytoncide to a compression and storage facility to produce packaged air or to be transported to an air cooling/heating facility for supplying fresh cooled/heated air;
and the hydraulic power generation device or the thermal power generation device supplying electrical power necessary for the above discussed operations, or alternatively or additionally, at least one wind power generation device, at least one solar energy generation device, or at least one tidal power generation device being installed to supply the necessary electrical power.

2. The method for retrieving and using natural resources according to claim 1, wherein the aggregate sieving and collecting area receive and desalt aggregates collected with an aggregate drawing and pumping device.

3. The method for retrieving and using natural resources according to claim 2, wherein the aggregate drawing and pumping device draws aggregates from river bottom or sea bottom.

4. The method for retrieving and using natural resources according to claim 1, wherein the desalting area is arranged to draw river water to wash aggregates in order to remove salt from the aggregates.

5. The method for retrieving and using natural resources according to claim 1, wherein the desalting area is arranged to draw river water that is heated together with aggregates in order to remove salt from the aggregates.

6. The method for retrieving and using natural resources according to claim 1, wherein the desalting area is arranged to heat aggregates and then drawing river water to mix with the aggregates for cooling in order to remove salt from the aggregates.
